(19) United States
(12) Patent Application Publication
(10) Pub. No.: US 2011/0204555 A1
(43) Pub. Date: Aug. 25, 2011

(54) TOOL FOR SPRINKLER HEAD INSTALLATION OR REPAIR

(76) Inventors: Kristin Babcock, Riverside, CA (US); Michael Babcock, Riverside, CA (US)

(21) Appl. No.: 12/712,685

(22) Filed: Feb. 25, 2010

(51) Int. Cl. B23Q 3/00

(52) U.S. Cl. 269/287

(57) ABSTRACT

Herein is described a device to keep the pop-up portion of a sprinkler in an upright position having a flexible strap with a hole near one end of said strap where the strap is capable of being wrapped around the pop-up portion of a sprinkler and the end of the strap farthest from the hole is capable of being secured through the hole in the strap such that the pop-up portion of the sprinkler is immobilized in an upright position allowing the user the ability to mark and adjust the sprinkler head.

### BACKGROUND OF THE INVENTION

The present invention generally relates to sprinkler maintenance and, more specifically, to devices to keep the pop-up portion of the sprinkler in place while replacing or adjusting head.

As can be seen, there is a need for a device to keep the pop up portion of the sprinkler in an upright position marking it and making it easily accessible for installation or repair.

### SUMMARY OF THE INVENTION

One aspect of the present invention is a device to keep the pop-up portion of a sprinkler in an upright position comprising: a flexible strap having a hole near one end of said strap where the strap is capable of being wrapped around the pop-up portion of a sprinkler and the end of the strap farthest from the hole is capable of being secured through the hole in the strap such that the pop-up portion of the sprinkler is immobilized in an upright position allowing the user the ability to mark and adjust the sprinkler head.

These and other features, aspects and advantages of the present invention will become better understood with reference to the following drawings, description and claims.

### BRIEF DESCRIPTION OF THE DRAWINGS

FIG. 1 depicts front, back and side views of an exemplary embodiment of the device.

FIG. 2 depicts front, back, and side views of an alternative exemplary embodiment of the device.

### DETAILED DESCRIPTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below

Broadly, an embodiment of the present invention generally describes a device to keep the pop-up portion of a sprinkler in an upright position marking it and making it easily accessible for installation or repair.

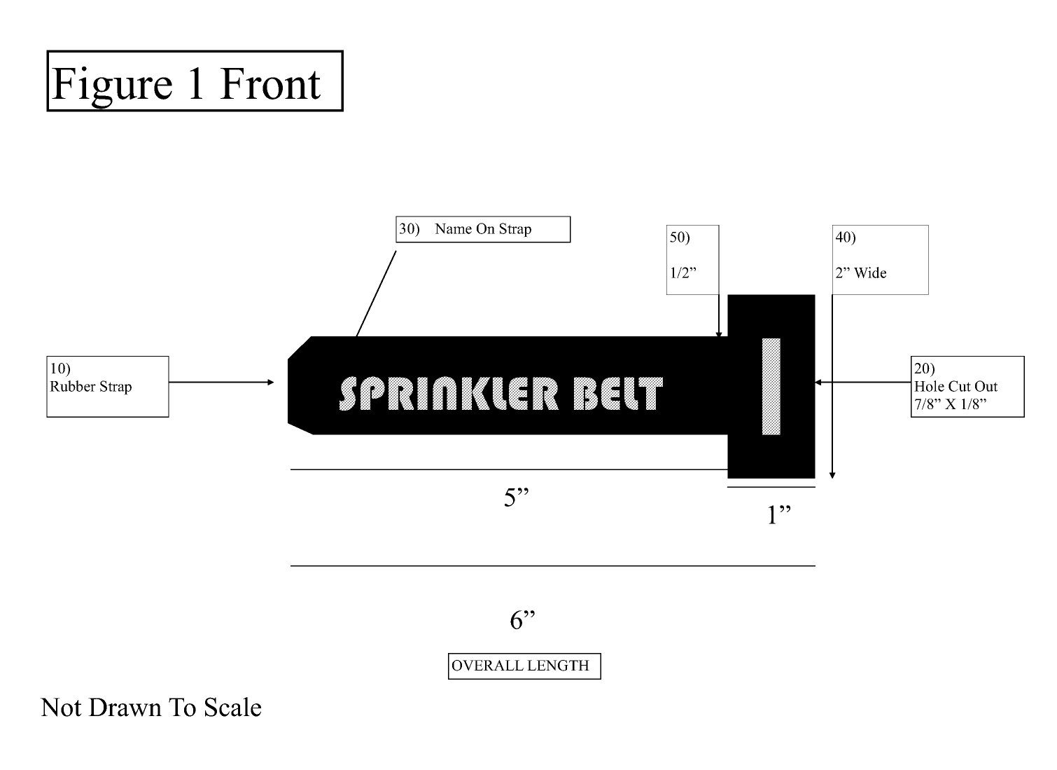

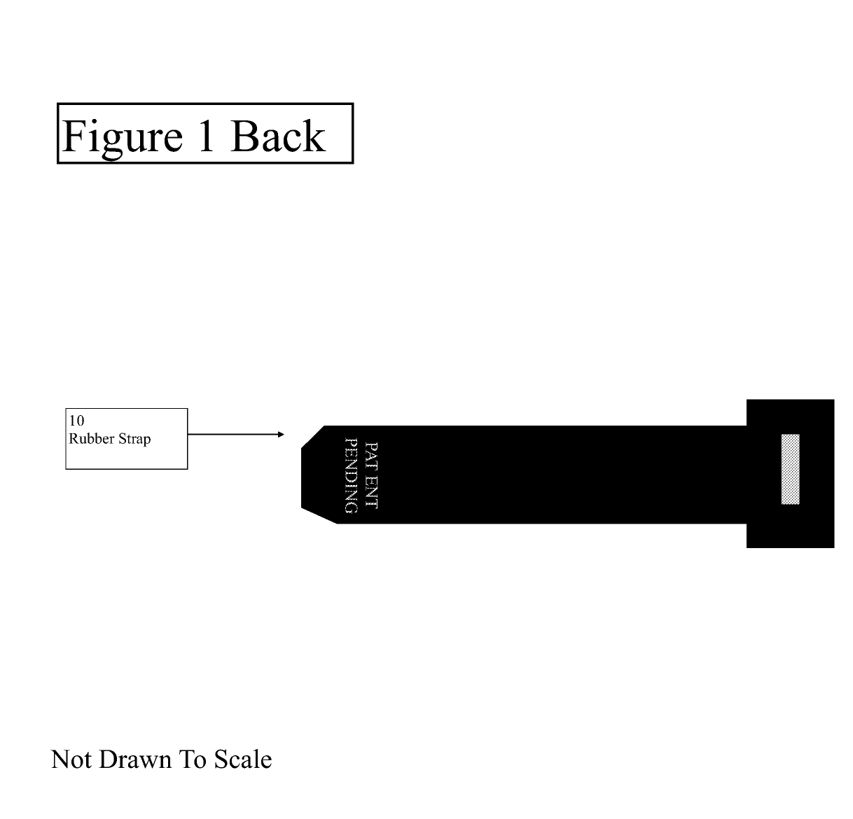

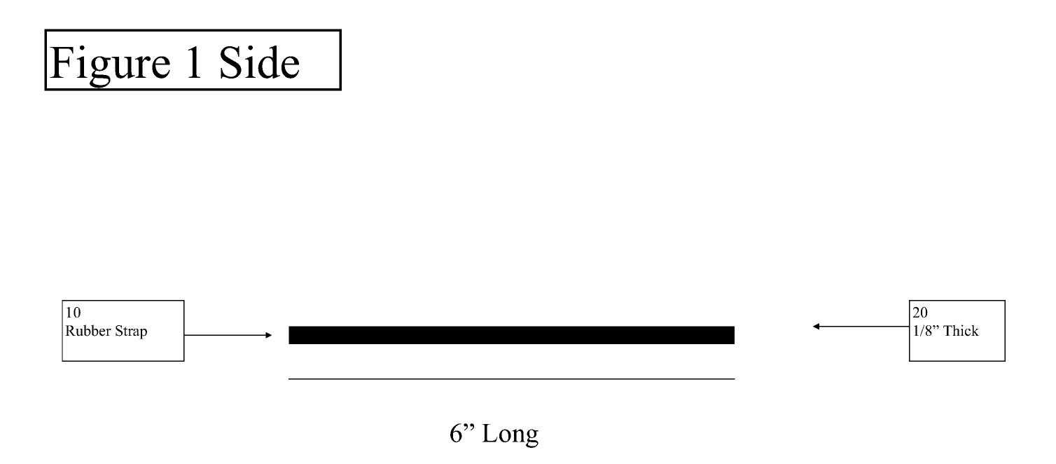

One embodiment of the device (see FIG. 1) comprises strap (10) that is a piece of rubber or other flexible material five or more inches long by about 0.75 inches wide (10) having a logo (30) on the front. A rubber buckle about 2 inches wide (40) by about 1 inch long is continuous with the strap (10) at one end, and has a hole (20) about ⅞ inch by ⅛ inch cut into the buckle such that the opposite end of the strap (10) can be placed through the hole (20). The strap (10) is placed around the pop-up portion of the sprinkler and then slid through hole (20) in the rubber buckle and pulled until taut.

When the strap (10) it is wrapped around the sprinkler head and is secured through the hole (20) in the rubber buckle, it allows the pop-up portion of the sprinkler to be immobilized in an upright position allowing the user the ability to mark and adjust the sprinkler head.

To use the device, locate a sprinkler that needs adjustment or head replacement, wrap the strap (10) around the pop-up portion of the sprinkler pulling the strap (10) through the hole (20) in the buckle until it is secured. The sprinkler should then be in place. After repair or adjustment is completed, release strap (10) from the hole (20) in the buckle to remove the device.

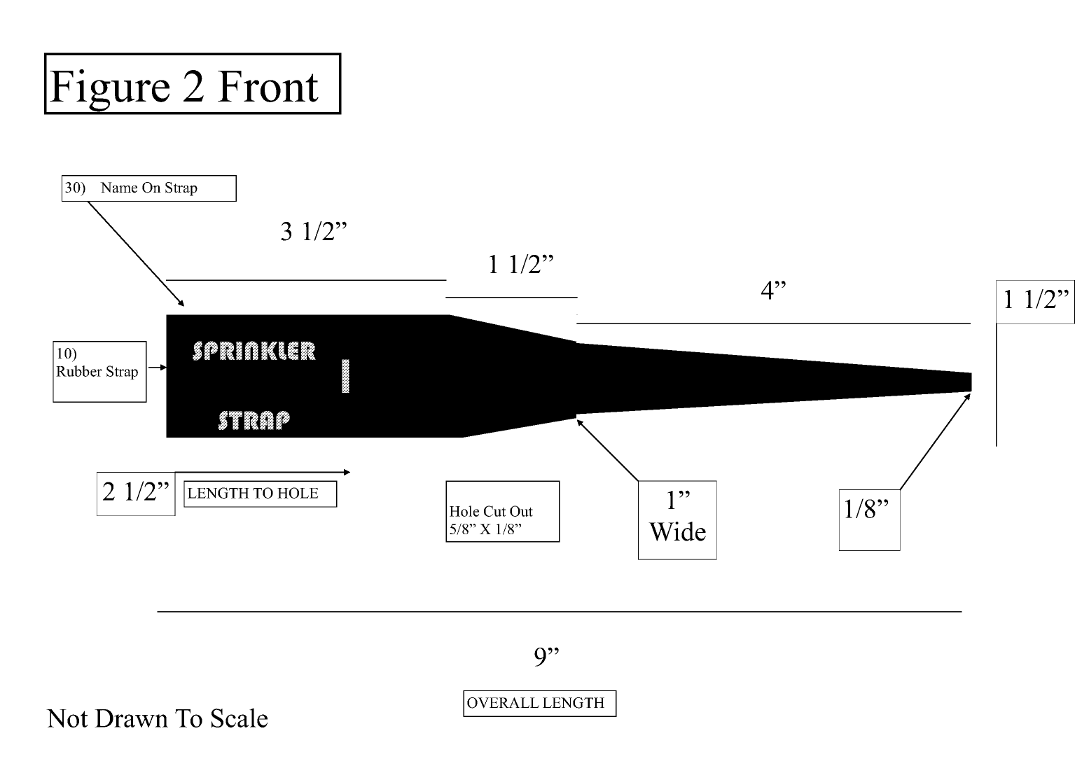

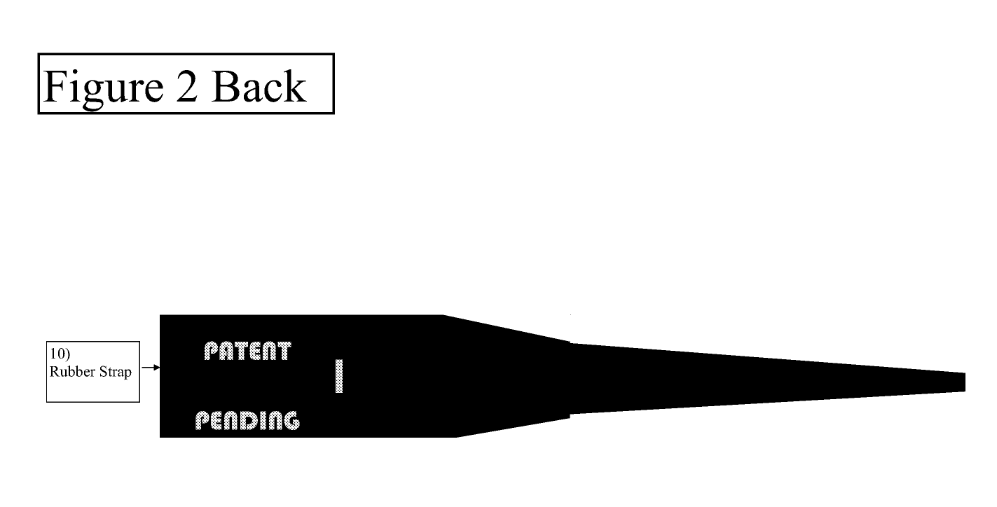

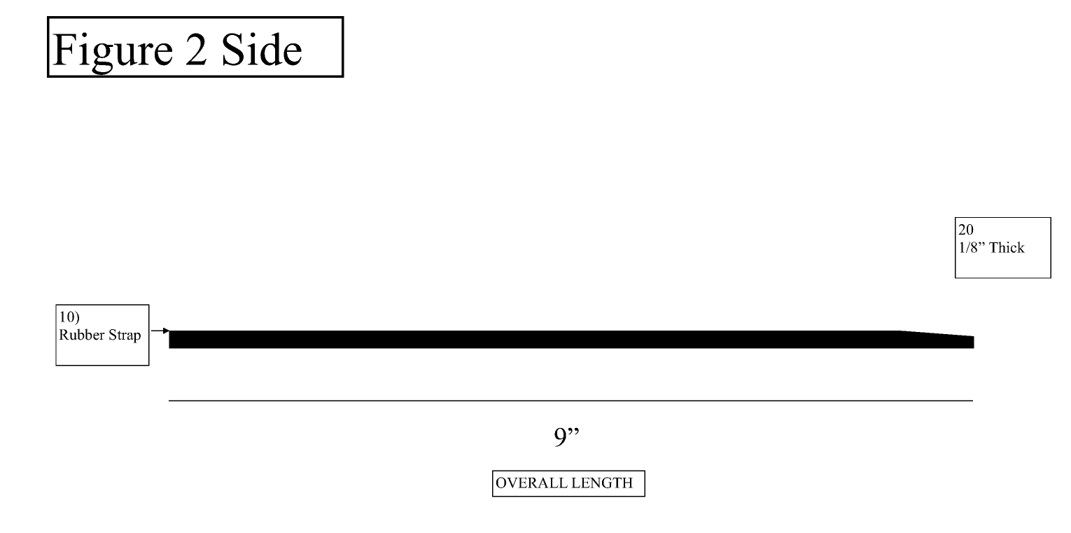

Another embodiment of the device (see FIG. 2) comprises strap (10) that is a piece of rubber or other flexible material nine or more inches long and of taper width from about 1.5 inches to about ⅛ inch having a logo (30) on the front. A hole is cut about 2.5 inches from the wider end of the strap such that the narrower end of the strap (10) can be placed through the hole. The strap (10) is placed around the pop-up portion of the sprinkler and then slid through hole in the rubber strap (10) and pulled until taut.

Alternative embodiments include adjustments to the width and length of the strap (10), placement of the hole (20), and alternative materials for the flexible strap (10). Alternative applications of the device include wrapping wires, as well as a hose and belt holder for vehicles, planes, engines, and the like.

It should be understood, of course, that the foregoing relates to exemplary embodiments of the invention and that modifications may be made without departing from the spirit and scope of the invention as set forth in the following claims.

What is claimed is:

1. A device to keep the pop-up portion of a sprinkler in an upright position comprising: a flexible strap having a hole near one end of said strap where the strap is capable of being wrapped around the pop-up portion of a sprinkler and the end of the strap farthest from the hole is capable of being secured through the hole in the strap such that the pop-up portion of the sprinkler is immobilized in an upright position allowing the user the ability to mark and adjust the sprinkler head.
